(19) United States
(12) Patent Application Publication
(10) Pub. No.: US 2011/0289434 A1
(43) Pub. Date: Nov. 24, 2011

(54) Certified URL checking, caching, and categorization service

(75) Inventor: DENIS KIEFT, San Jose, CA (US)

(73) Assignee: BARRACUDA NETWORKS, INC., Campbell, CA (US)

(21) Appl. No.: 12/784,471

(22) Filed: May 20, 2010

(51) Int. Cl. G06F 21/00; G06F 15/16; G06F 3/048

(52) U.S. Cl. 715/760; 726/23

(57) ABSTRACT

Disclosed is a method, a computer system and a computer readable media product that contains a set of computer executable software instructions for directing the computer system to execute a process for generating improved abbreviated uniform resource identifiers (URI) commonly called an URL. A system comprises an URL shortening server, coupled to a web filter, coupled to a proxy server, coupled to a domain name system server. A user may append host and domain as a suffix to a shortened URL to request at least one of web filtering, categorization, and preview before redirection to the site. A site receives a request for an abbreviated URL or a categorized abbreviated URL which is provided upon passing a webfilter.

### BACKGROUND

URL shortening is a practice which reduces a target uniform resource identifier(URI), historically a universal resource locator (URL) to a much shorter character string which can easily be transmitted in an email or a social network communication which might support fewer characters in a message or in a line. Descriptive titles of documents in deep hierarchies may exceed the number of characters allowed in popular protocols. However, not knowing where you'll end up after clicking on a link shared through a compact or short messaging exchange such as Twitter has become a hazard exploited by spammers, phishers and scammers. Even if sent with humorous intent, the content may be inappropriate for a work or family display. Another hazard are bar codes and QR codes. A QR code is analogous to a barcode which can carry provide a protocol and domain name which can be read by a scanner and requested through a browser. It is not human readable and can be thus used to distribute malicious software.

One solution is for an URLshortening service provider to partner with other entities:

Verisign's iDefense service will screen IP addresses, domains and URLs based on its reputation database, to find those that “host exploits, malicious code, command and control servers, drop sites and other nefarious activity,”.

WebSense's ThreatSeeker Cloud will analyze the content on pages linked to through Bit.ly in real-time to identify and block “spammy URLs, malicious content and phishing sites.”

Meanwhile, Sophos rounds out the equation by analyzing the behavior of potential spammers to “go beyond blacklists, to proactively detect spam and malware.”

An other solution is for search providers to offer their own closed system which includes scanning as a part of generating shortened URLs. e. g. goo.gl

What is needed is a way to check or categorize abbreviated URL's which are naturally obfuscated. Alternately, a URL shortening service that pre-checks, categorizes, or previews would avoid embarrassment and potential harm.

### SUMMARY OF THE INVENTION

A system comprising an URL shortening server, coupled to a web filter, coupled to a proxy server, coupled to a domain name system server. A user may append a suffix comprising a host and domain e.g. “.host.domain.tld” to a shortened URL to request at least one of web filtering, categorization, and preview before redirection to the site. A site may request an abbreviated url or a categorized abbreviated URL which is provided upon passing a webfilter.

When a user presents a URL for shortening, a server embodying the improved service performs a malware check in depth on the resource which is the target of the URL. The URL is shortened and provided to the user for sending to his friends or posting. When the shortened URL is used, it comes back to the shortening service provider for expansion. In the event that a javascript is used to adjust links on the target resource, a server can check the javascript for malware, and cache a proven non-malicious javascript. In an embodiment the request is redirected. In an embodiment the request is proxied.

In an embodiment the target of the URL is categorized and the shortened URL provided to the user includes a clue as to the type of content it points to. In an embodiment, the shortened URL may resemble a hierarchical directory with the type of content shown in the path e.g. http://cu.da/adult/antehujjkkhil 344 http://cu.da/music/cgpcgyl 34870 http://te.st/rickroll/ditena94950265

Any other shortened URL can be checked as well by appending a service provider test host and domain to the shortened URL. The service provider can redirect the request using a DNS server to his own service and proxy the request. So in an example, if a shortened URL is http://bit.ly/asdf a user may add the suffix conceptually illustrated by but not limited to e.g. .te.st or .if.ok which will first initiate a dns query to the dns server of te.st which the service provider can resolve to its own certified url proxy. A warning may be presented to the user prior to redirecting or proxying the request.

### BRIEF DESCRIPTION OF DRAWINGS

FIG. 1 illustrates processor means for embodying the invention as a system. FIGS. 2-3 are flowchart for creating improved abbreviated URL. FIGS. 4-6 are flowchart for improved resolution of abbreviated URL.

### DETAILED DISCLOSURE OF EMBODIMENTS

An apparatus comprises a conventional processor configured as means to operate the following method.

A method for operating a service which filters an abbreviated or obfuscated uniform resource identifier (URI) comprises:
receiving an obfuscated URI prepended to the domain of the service as a request;
removing the suffix of the domain of the service;
checking the obfuscated URI in a webfilter to determine its category, and
proxying or redirecting the request to the obfuscated URI if it is not malicious.

In an embodiment the method further comprises displaying a low resolution static thumbnail of the endpoint in a document with a user input to continue or abort.

In an embodiment the method further comprises displaying a categorization warning in a document with a user input to continue or abort.

A method for operating a service which generates improved abbreviated uniform resource identifiers (URI) comprises the following:
receiving request to abbreviate a clear URI;
categorizing the endpoint of the URI; and
   if the content is not categorized as malicious,
generating an abbreviated URI and storing the corresponding clear URI; and returning the abbreviated URI;
   if the content is categorized as malicious,
displaying an explanation why the request was denied.

In an embodiment the method further comprises
returning an abbreviated URI with an embedded category string embedded.

In an embodiment the method further comprises
returning an abbreviated URI with a category string as a hierarchical path.

In an embodiment the method further comprises
returning an abbreviated URI with a cautionary warning string embedded.

In an embodiment the method further comprises
receiving an abbreviated URI, and
   if the content at the endpoint has not changed,
proxying or redirecting to the clear URI and
   if the content has changed since the abbreviated URI was generated,
recategorizing the content and if the category has changed
displaying a warning in a document with a user input to continue or abort.

An embodiment of the invention comprises an URL shortening server, a web filter, a web proxy, and a security database application operating as domain name service server.

The URL shortening server receives a request to shorten an URL, submits it to the web filter, on the condition the URL passes all malware checks, and generates a shortened URL which is returned to the requestor.

When the shortened URL is requested by a user, a first DNS request is received by the security database application operating as a domain name system server. Instead of merely responding with an IP address, the security database application parses the entire requested URL, checks the target resource for malware and returns either a IP address containing a warning or the IP address of the web proxy.

In an embodiment the method further comprises
receiving an abbreviated uniform resource identifier,
recategorizing the content of the resource and
   if the category has changed
displaying a warning in a document with a user input to continue or abort and
proxying or redirecting to the clear URI and caching the checked resource.

In an embodiment the method further comprises
downloading a browser executable program,
dynamically or statically analyzing the browser executable program,
   if the browser executable program is not malicious
caching and forwarding the browser executable program to the requestor of the abbreviated uniform resource identifier.

In an embodiment the method further comprises
downloading a browser executable program,
statically or dynamically analyzing the browser executable program,
   if the browser executable program is not malicious
caching the result of the browser executable program and forwarding the result of the browser executable program to the requestor of the abbreviated uniform resource identifier.

In an other embodiment, a user may append a host and domain to the end of a shortened URL provided by an other URL shortening service. The security database application operating as a domain name system server will parse the request and use the web proxy to obtain the target URL from the other URL shortening service. The web filter will check the target URL for malware.

In an other embodiment, a URL may point to a website which has changed since it was last scanned for malware. When a shortened URL is received by the web proxy, the target URL is determined by checking a security database and the web filter checks the URL for malware. If there is malware the web proxy redirects the user to a warning message.

In an embodiment, a firewall may direct all DNS requests for shortened URL services to the security database application operating as a domain name system server. This would relieve the user from having to append a special domain to any shortened URL.

Certain trusted URL shortening services with effective malware filters may be configured into the firewall.

QR codes may be placed on products, billboards, or on buildings for scanning by mobile devices with cameras, scanning, software, and Internet browsers. These QR codes may also resolve to an URL having malware. In an embodiment, QR code scanning software will direct its DNS query to a security database application operating as a DNS server.

In an embodiment, the method further comprises receiving a browser executable program such as javascript, statically analyzing it for malicious behavior, and caching the browser executable program if it is not malicious.

In an embodiment, the method further comprises receiving a browser executable program such as javascript, dynamically analyzing it for malicious behavior, and caching the browser executable program if it is not malicious.

In an embodiment, the method comprises caching links which are manipulated by a browser executable program and rewriting the links to the cached version when responding to a request for a shortened URL.

In an embodiment, the method further comprises receiving a browser executable program such as javascript, dynamically analyzing it to determine a category for the endpoint at the end of a path generated by the program, and providing a shortened URL comprising a category name.

In an embodiment, the method further comprises prefiltering all of the links on a document which is the endpoint of a URL which is nominated for shortening, and providing a shortened URL if all of the links are non-malicious.

In an embodiment, the method further comprises storing a thumbnail of the endpoint of all the links on a document which is the endpoint of a URL which is nominated for shortening and redirecting the request to the thumbnail in lieu of the actual endpoint when the shortened URL is requested. A thumbnail is defined as a static, low resolution, reduced scale non-executing image of the resource. In the case of an audio file it would comprise the meta data describing the title, copyright, hosting service, and composer if known.

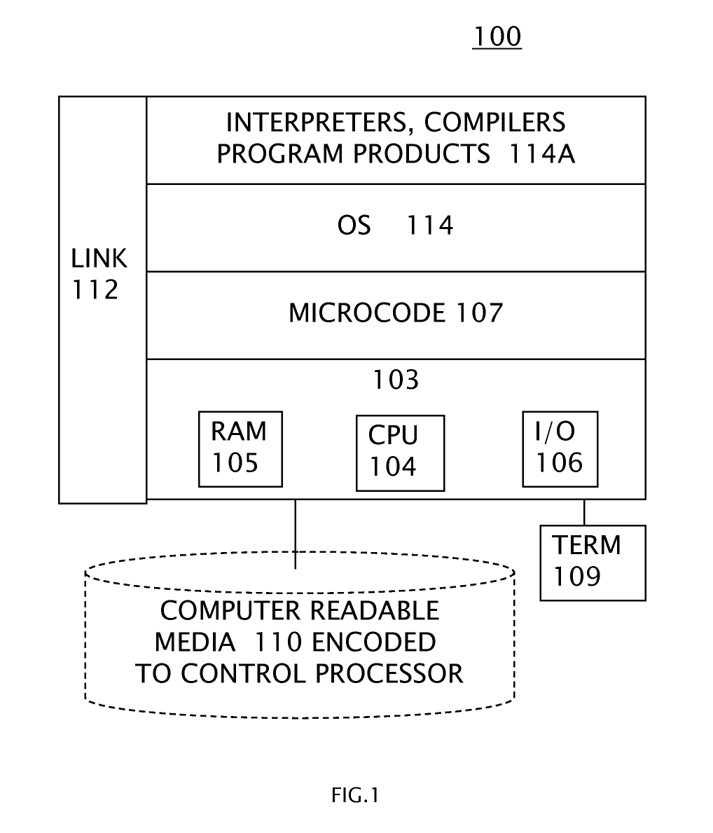

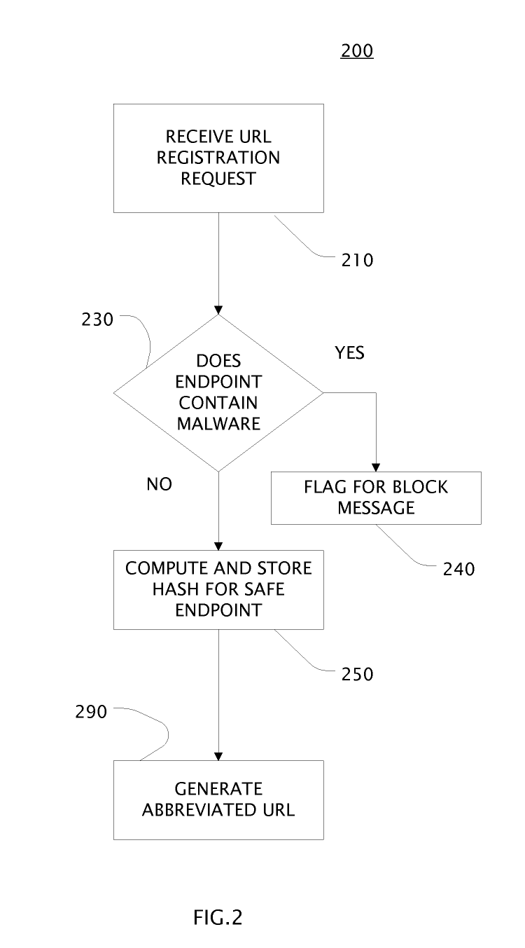

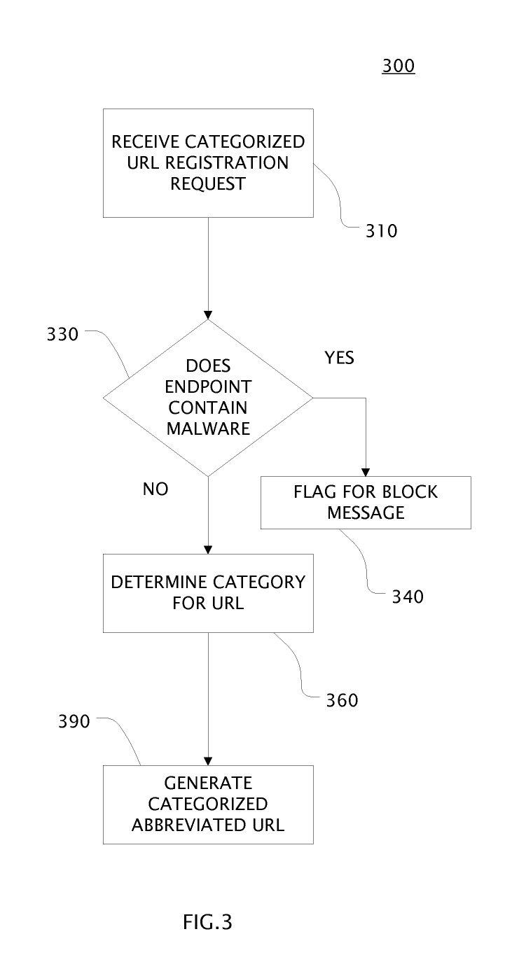

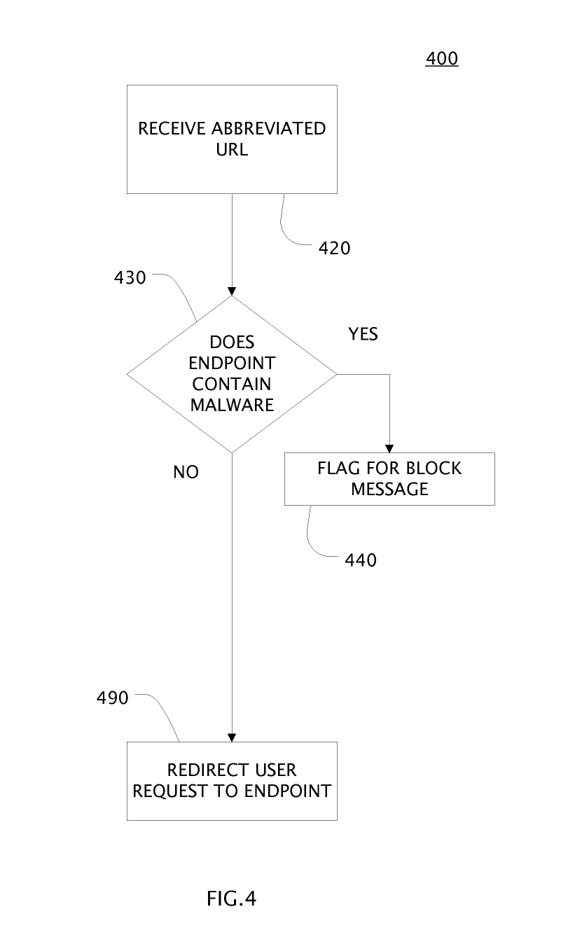

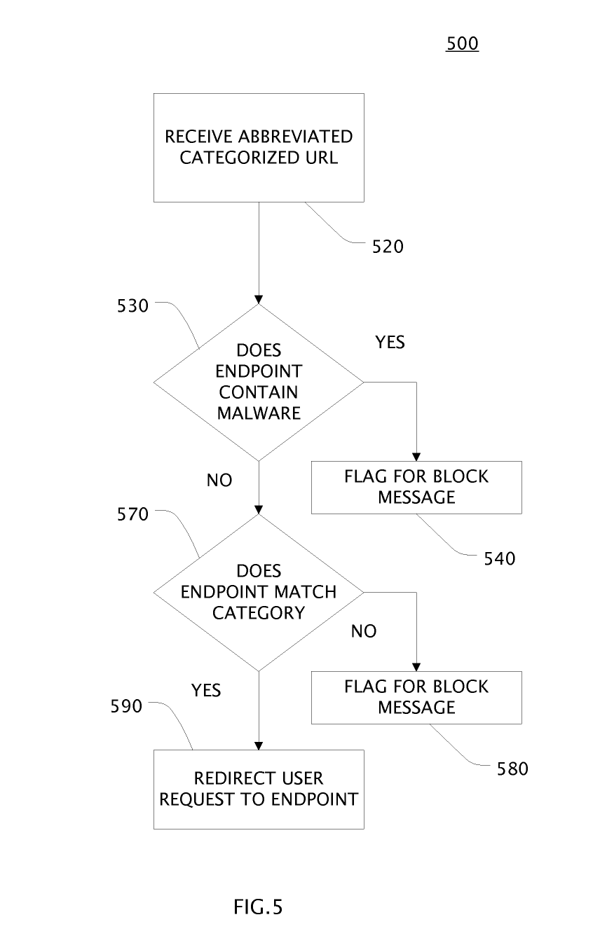

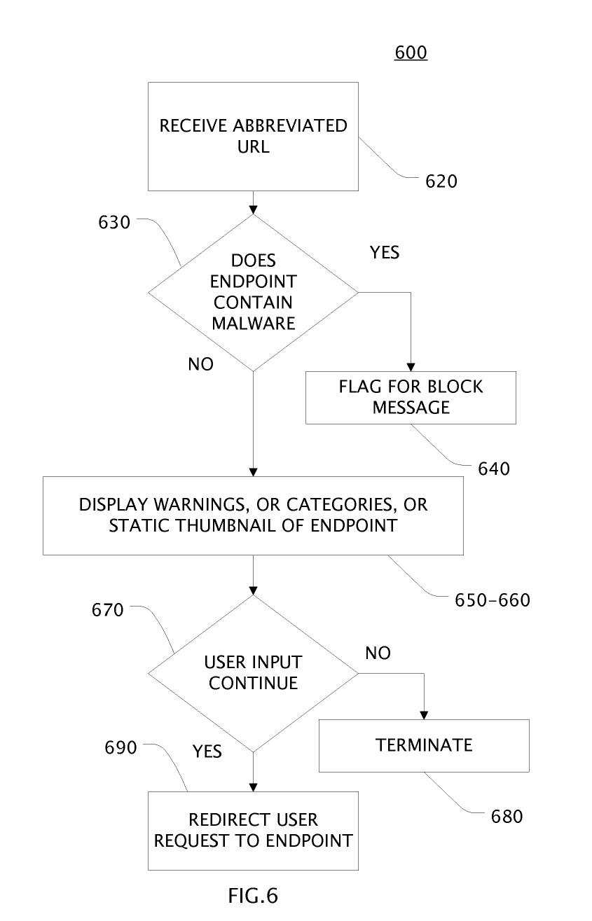

Referring now to the figures, FIG. 1 is a block diagram of a conventional processor means for embodying the invention in a processor configured to generate or fulfill request to an abbreviated URL. FIG. 1 illustrates a non-limiting exemplary conventional server known in the art comprising hardware and software configured to execute instructions and communicate to attached networks and input output devices. A processor, circuit, or programmable logic configured by instructions in a computer readable device as discussed below provides means for enabling any of the functions claims.

FIG. 2 illustrates a method for generating an abbreviated URL upon request comprising receiving the request to register a URL 210, checking to determine if the URL delivers malware 230, if so preparing a block message 240, if not determining a hash for the endpoint for future reference, e.g. rechecking if the content has changed and generating an abbreviated URL 290.

FIG. 3 an improved method comprising receiving a request for a categorized abbreviated URL 310, checking if the endpoint contains malware 330, flagging the page for a block message if so, and if not, determining a category for the class of content 360, and generating a categorized abbreviated URL. Thus the abbreviated link contains some clue as to the endpoint category and represents that the URL service has checked for malware.

FIG. 4 is a method for handling a request for a resource linked by an abbreviated URL 420. If the endpoint have malware, 430 it will be flagged to present a block message to the user 440; and if clean, redirecting the user request to the endpoint 490 and relaying the reply.

FIG. 5 is an improved method for responding to a categorized URL. The method comprises receiving an abbreviated categorized URL 520. The endpoint of the URL is analyzed for malicious software which may be potentially harmful or undesireable 530. In embodiments this analysis may be static or dynamic analysis of browser executable programs such as javascripts, html, flash, or other downloadable code. If the endpoint is malicious, the URL is flagged for a block message 540. If the endpoint is not malicious it is still checked to see if it matches the category previously assigned 570. If the category does not match the category assigned when the shortened URL was created, it is flagged for a block message 580. If the category matches the original category, even if the content is modified from its initial content at the time the shortened URL was generated, the user request is redirected or proxied to the endpoint 590.

FIG. 6 is an improved method that displays a category or low resolution static thumbnail-sized preview as a warning to allow the user to abort an undesirable download. The method comprises receiving 620 a shortened or abbreviated uniform resource identifier, popularly referred to as the deprecated universal resource locator URL. A webfilter application determines if the resource traced through one or more redirections contains malicious software 630 that may be potentially harmful or simply undesirable. A series of redirections may indicate a potential for malicious behavior. Such deceitful linking or the analysis of the endpoint of the URL may result in flagging the abbreviated URL for a block message 640. In an embodiment webfilter application may determine categories for the endpoint and a message may be displayed. In an embodiment, a static thumbnail of the endpoint may be displayed. In an embodiment, other warnings from the webfilter may be displayed 650-660. In an embodiment, the user has an input control to abort or continue with the request 670. If the user chooses not to continue, the process terminates 680. If the user chooses to continue the request is fulfilled 690. Fulfillment may be by redirection or by proxy.

In an aspect of the invention, an apparatus comprises a network device, comprising: a processor, wherein the processor is operable to provide a service which filters an abbreviated or obfuscated uniform resource identifier (URI) to:
receive an obfuscated URI prepended to the domain of the service as a request;
remove the suffix of the domain of the service;
check the obfuscated URI in a webfilter to determine its category, and
proxy the request to the obfuscated URI if it is not malicious.

In an embodiment the network device is further configured to:
display a low resolution static thumbnail of the endpoint in a document with a user input to continue or abort.
or to
   display a categorization warning in a document with a user input to continue or abort.

In an other aspect of the invention, an apparatus comprises a network device, comprising: a processor, wherein the processor is operable to provide a service which generates improved abbreviated uniform resource identifiers (URI) to:
receive request to abbreviate a clear URI;
categorize the endpoint of the URI; and
if the content is not categorized as malicious,
   generate an abbreviated URI and storing the corresponding clear URI; and returning the abbreviated URI;
if the content is categorized as malicious,
   display an explanation why the request was denied.

In embodiments the apparatus is a network device further configured to at least one of:
return an abbreviated URI with an embedded category string embedded.
return an abbreviated URI with a category string as a hierarchical path.
return an abbreviated URI with a cautionary warning string embedded.
   receive an abbreviated uniform resource identifier,
   recategorize the content of the resource and
if the category has changed
   display a warning in a document with a user input to continue or abort and
proxy to the clear URI and cache the checked resource.
   download a browser executable program,
dynamically analyze the browser executable program,
if the browser executable program is not malicious
   forward the browser executable program to the requestor of the abbreviated uniform resource identifier.
      cache the result of the browser executable program and forward the result of the browser executable program to the requestor of the abbreviated uniform resource identifier.

An embodiment of the invention comprises a system comprising a processor communicatively coupled to a computer-readable medium for operating a service which filters an abbreviated or obfuscated uniform resource identifier (URI), comprising at least one sequence of instructions, wherein execution of the instructions by a processor configures the processor to perform at least one of the steps of:
receiving an obfuscated URI prepended to the domain of the service as a request;
removing the suffix of the domain of the service;
checking the obfuscated URI in a webfilter to determine its category, and
proxying the request to the obfuscated URI if it is not malicious.

In an embodiment the computer-readable medium further comprising at least one sequence of instructions to perform the steps of
displaying a low resolution static thumbnail of the endpoint in a document with a user input to continue or abort.
displaying a categorization warning in a document with a user input to continue or abort.

An embodiment of the invention comprises a system comprising a processor communicatively coupled to a computer-readable medium for operating a service which generates improved abbreviated uniform resource identifiers (URI) comprising at least one sequence of instructions, wherein execution of the instructions by a processor configures the processor to perform the steps of:
receiving request to abbreviate a clear URI;
categorizing the endpoint of the URI; and
if the content is not categorized as malicious,
   generating an abbreviated URI and storing the corresponding clear URI; and returning the abbreviated URI;
if the content is categorized as malicious,
   displaying an explanation why the request was denied.

In an embodiment the computer-readable medium further comprising at least one sequence of instructions to perform the steps of
returning an abbreviated URI with an embedded category string embedded.
returning an abbreviated URI with a category string as a hierarchical path.
returning an abbreviated URI with a cautionary warning string embedded.
receiving an abbreviated uniform resource identifier,
recategorizing the content of the resource and
if the category has changed
   displaying a warning in a document with a user input to continue or abort and
   proxying or redirecting to the clear URI and caching the checked resource.

In an embodiment the computer-readable medium further comprising at least one sequence of instructions to perform the steps of
downloading a browser executable program,
dynamically or statically analyzing the browser executable program,
if the browser executable program is not malicious
   forwarding the browser executable program to the requestor of the abbreviated uniform resource identifier.
      caching the result of the browser executable program and forwarding the result of the browser executable program to the requestor of the abbreviated uniform resource identifier.

### CONCLUSION

The invention may be distinguished from conventional URL shortening services by filtering independently generated URL's as well as its own. A preview or warning is displayed allowing the user to abort a request if it is undesired. The invention categorizes and webfilters requests to shorten a URL and embeds a category string into the short URL.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Although not required, aspects of the invention have been described herein in the general context of computer-executable instructions, such as program modules, being executed by computers 100 in network environments. A example of a computer in a horizontally scalable system is illustrated in FIG. 1 comprising a server 100. Said server comprises a processor 103 configured by microcode 107, an operating system 114, and in embodiments interpreters, compilers, and program products 114A. Such a system is coupled to other servers through a network link 112, and to a local or remote terminal 109. A conventional processor 103 comprises random access memory 105, a central processing unit 104 and an input output circuit 106. Generally, program modules include routines, programs, objects, components, and content structures that perform particular tasks or implement particular abstract content types. Computer-executable instructions, associated content structures, and program modules represent examples of program code for executing aspects of the methods disclosed herein.

Further, the steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. While the foregoing disclosure shows illustrative aspects and/or aspects, it should be noted that various changes and modifications could be made herein without departing from the scope of the described aspects and/or aspects as defined by the appended claims. Furthermore, although elements of the described aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

Many modifications and other aspects of the invention will come to mind to one skilled in the art to which this invention pertains having the benefit of the teachings presented in the foregoing descriptions and the associated drawings. Therefore, it is to be understood that the invention is not to be limited to the specific aspects disclosed and that modifications and other aspects are intended to be included within the scope of the appended claims. Although specific terms are employed herein, they are used in a generic and descriptive sense only and not for purposes of limitation.

What is claimed is:

1. A computer executed method for operating a service which filters an abbreviated or obfuscated uniform resource identifier (URI) comprising
receiving an obfuscated URI prepended to the domain of the service as a request;
removing the suffix of the domain of the service;
checking the obfuscated URI in a webfilter to determine its category, and
proxying the request to the obfuscated URI if it is not malicious.

2. The method of claim 1 further comprising
displaying a low resolution static thumbnail of the endpoint in a document with a user input to continue or abort.

3. The method of claim 1 further comprising
displaying a categorization warning in a document with a user input to continue or abort.

4. A computer executed method for operating a service which generates improved abbreviated uniform resource identifiers (URI) comprising the following:
receiving request to abbreviate a clear URI;
categorizing the endpoint of the URI; and
if the content is not categorized as malicious,
generating an abbreviated URI and storing the corresponding clear URI;
and returning the abbreviated URI;
if the content is categorized as malicious,
displaying an explanation why the request was denied.

5. The method of claim 4 further comprising
returning an abbreviated URI with an embedded category string embedded.

6. The method of claim 4 further comprising
returning an abbreviated URI with a category string as a hierarchical path.

7. The method of claim 4 further comprising
returning an abbreviated URI with a cautionary warning string embedded.

8. The method of claim 4 further comprising
receiving an abbreviated uniform resource identifier,
recategorizing the content of the resource and
if the category has changed
displaying a warning in a document with a user input to continue or abort and
proxying or redirecting to the clear URI and caching the checked resource.

9. The method of claim 8 further comprising
downloading a browser executable program,
dynamically analyzing the browser executable program,
if the browser executable program is not malicious
forwarding the browser executable program to the requestor of the abbreviated uniform resource identifier.

10. The method of claim 8 further comprising
downloading a browser executable program,
dynamically analyzing the browser executable program,
if the browser executable program is not malicious
caching the result of the browser executable program and forwarding the result of the browser executable program to the requestor of the abbreviated uniform resource identifier.

11. A network device, comprising: a processor, wherein the processor is operable to provide a service which filters an abbreviated or obfuscated uniform resource identifier (URI) to:
receive an obfuscated URI prepended to the domain of the service as a request;
remove the suffix of the domain of the service;
check the obfuscated URI in a webfilter to determine its category, and
proxy the request to the obfuscated URI if it is not malicious.

12. The network device of claim 11, further configured to:
display a low resolution static thumbnail of the endpoint in a document with a user input to continue or abort.

13. The network device of claim 11, further configured to:
display a categorization warning in a document with a user input to continue or abort.

14. A network device, comprising: a processor, wherein the processor is operable to provide a service which generates improved abbreviated uniform resource identifiers (URI) to:
receive request to abbreviate a clear URI;
categorize the endpoint of the URI; and
if the content is not categorized as malicious,
generate an abbreviated URI and storing the corresponding clear URI;
and returning the abbreviated URI;
if the content is categorized as malicious,
display an explanation why the request was denied.

15. The network device of claim 14, further configured to:
return an abbreviated URI with an embedded category string embedded.

16. The network device of claim 14, further configured to:
return an abbreviated URI with a category string as a hierarchical path.

17. The network device of claim 14, further configured to:
return an abbreviated URI with a cautionary warning string embedded.

18. The network device of claim 14, further configured to:
receive an abbreviated uniform resource identifier,
recategorize the content of the resource and
if the category has changed
display a warning in a document with a user input to continue or abort and
proxy to the clear URI and cache the checked resource.

19. The network device of claim 18, further configured to:
download a browser executable program,
dynamically analyze the browser executable program,
if the browser executable program is not malicious
forward the browser executable program to the requestor of the abbreviated uniform resource identifier.

20. The network device of claim 18, further configured to:
download a browser executable program,
dynamically analyze the browser executable program,
if the browser executable program is not malicious
cache the result of the browser executable program and forward the result of the browser executable program to the requestor of the abbreviated uniform resource identifier.

21. A computer-readable medium for operating a service which filters an abbreviated or obfuscated uniform resource identifier (URI), comprising at least one sequence of instructions, wherein execution of the instructions by a processor configures the processor to perform the steps of:
receiving an obfuscated URI prepended to the domain of the service as a request;
removing the suffix of the domain of the service;
checking the obfuscated URI in a webfilter to determine its category, and
proxying the request to the obfuscated URI if it is not malicious.

22. The computer-readable medium of claim 21, further comprising at least one sequence of instructions to perform the steps of
displaying a low resolution static thumbnail of the endpoint in a document with a user input to continue or abort.

23. The computer-readable medium of claim 21, further comprising at least one sequence of instructions to perform the steps of
displaying a categorization warning in a document with a user input to continue or abort.

24. A computer-readable medium for operating a service which generates improved abbreviated uniform resource identifiers (URI) comprising at least one sequence of instructions, wherein execution of the instructions by a processor configures the processor to perform the steps of:
receiving request to abbreviate a clear URI;
categorizing the endpoint of the URI; and
if the content is not categorized as malicious,
generating an abbreviated URI and storing the corresponding clear URI;
and returning the abbreviated URI;
if the content is categorized as malicious,
displaying an explanation why the request was denied.

25. The computer-readable medium of claim 24, further comprising at least one sequence of instructions to perform the steps of
returning an abbreviated URI with an embedded category string embedded.

26. The computer-readable medium of claim 24, further comprising at least one sequence of instructions to perform the steps of
returning an abbreviated URI with a category string as a hierarchical path.

27. The computer-readable medium of claim 24, further comprising at least one sequence of instructions to perform the steps of
returning an abbreviated URI with a cautionary warning string embedded.

28. The computer-readable medium of claim 24, further comprising at least one sequence of instructions to perform the steps of
receiving an abbreviated uniform resource identifier,
recategorizing the content of the resource and
if the category has changed
displaying a warning in a document with a user input to continue or abort and
proxying or redirecting to the clear URI and caching the checked resource.

29. The computer-readable medium of claim 28, further comprising at least one sequence of instructions to perform the steps of
downloading a browser executable program,
dynamically analyzing the browser executable program,
if the browser executable program is not malicious
forwarding the browser executable program to the requestor of the abbreviated uniform resource identifier.

30. The computer-readable medium of claim 28, further comprising at least one sequence of instructions to perform the steps of
downloading a browser executable program,
dynamically analyzing the browser executable program,
if the browser executable program is not malicious
caching the result of the browser executable program and forwarding the result of the browser executable program to the requestor of the abbreviated uniform resource identifier.
